(19) United States
(12) Patent Application Publication
(10) Pub. No.: US 2025/0258935 A1
(43) Pub. Date: Aug. 14, 2025

(54) SECURE AND AUTONOMOUS DATA ENCRYPTION AND SELECTIVE DE-IDENTIFICATION

(71) Applicant: Optum, Inc., Minnetonka, MN (US)

(72) Inventors: Kazuki SHINTANI, Cambridge, MA (US); Santhosh SARABU, San Antonio, TX (US); Ying ZHU, Champaign, IL (US)

(21) Appl. No.: 18/975,137

(22) Filed: Dec. 10, 2024

Related U.S. Application Data
(60) Provisional application No. 63/552,239, filed on Feb. 12, 2024.

(51) Int. Cl. G06F 21/60

(52) U.S. Cl. CPC G06F 21/602

(57) ABSTRACT

Various embodiments of the present disclosure provide automated encryption and data de-identification techniques for improving computer security. The techniques apply machine learning and encryption techniques to transform input data objects to tagged data objects that may be locally decrypted using encrypted element representation stored within the tagged data objects. The techniques may include determining a protected data element from an input data object based on privacy criteria and generating the tagged data object from the input data object by replacing the protected data element with an anonymized privacy tag that identifies a privacy type of the protected data element. The techniques may further include generating an encrypted element representation of the protected data element and inserting the encrypted element representation to a portion of the tagged data object to enable decryption of the tagged data object by authorized entities.

### CROSS REFERENCE TO RELATED APPLICATIONS

This application claims priority to U.S. Provisional Application No. 63/552,239, entitled “DATA DE-IDENTIFICATION”, filed Feb. 12, 2024, the entirety of which is incorporated by reference herein for all purposes.

### BACKGROUND

Various embodiments of the present disclosure address technical challenges of existing encryption and de-identification techniques. Traditional de-identification techniques fail to comprehensively remove sensitive information or, alternatively, redact both sensitive and non-sensitive information which may render digital documents unusable after encryption and/or de-identification. These technical challenges may be caused by nuances in the forms of sensitive information, which traditionally prevents the accurate detection of all protected data elements within a digital document, especially across diverse document types and domains that are governed by different data sensitivity criteria. For example, traditional techniques rely on pattern matching or keyword lists, which fail to capture context-dependent information, whereas more advanced natural language processing approaches fail to maintain document coherence and utility after redaction. Moreover, former techniques that redact sensitive information may lead to retrieval errors since the sensitive information may have previously been used as part of retrieving a file containing the sensitive information, among other technical challenges that frustrate the automated repopulation of a redacted document in appropriate circumstances.

Various embodiments of the present disclosure make important contributions to encryption and de-identification technologies by solving these technical challenges, among others.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of a de-identification process in accordance with some embodiments of the present disclosure.

FIG. 5 depicts an operational example of a parallel model pipeline in accordance with some embodiments of the present disclosure.

FIG. 6 depicts a flowchart diagram of an example de-identification process in accordance with some embodiments of the present disclosure.

### DETAILED DESCRIPTION

Various embodiments of the present disclosure solve technical challenges with encryption, de-identification, and retrieval of redacted digital documents by leveraging a de-identification and encryption process to enable less retrieval error prone and more accurate (e.g., decreased false positive and/or false negative rate(s)), scalable, secure, flexible, and selectively reversable protection of sensitive information in digital documents. To do so, the de-identification process combines a parallel model pipeline with encryption techniques to comprehensively detect and encrypt protected data elements within an input data object. Once encrypted, the protected data elements may be replaced within the input data object with anonymized term representations to securely store a resulting tagged data object that preserves the textual coherency of the input data object without exposing sensitive information of the input data object to a digital environment. This, in turn, enables the use of the tagged data object, in place of the input data object, for post processing tasks, such as data analysis and machine learning training, that may benefit from the non-sensitive information of the input data object. Moreover, the anonymized term representations may be linked to encrypted element representations that store encrypted versions of the protected data elements, such that the anonymized term representations may be used to selectively repopulate the tagged data object responsive to successful authentication of authorization credentials of an accessing entity (e.g., user, downstream model). To improve the retrieval accuracy, speed, and reliability of traditional decryption techniques, the encrypted element representations may be stored within the tagged data object to enable the local retrieval and repopulation of the tagged data object. Ultimately, this enables a separable tagged data object that may be accessed, transmitted, and stored across a plurality of different locations without impacting the usability or the security of the text within the tagged data object. In this manner, some of the techniques of the present disclosure provide improved encryption, de-identification, and digital document handling techniques that improve the security, severability, and usability of text within a digital environment.

Some embodiments of the present disclosure leverage a parallel model pipeline to address several technical challenges presented by the extraction of protected information from an input data object. To do so, the parallel model pipeline instantiates a set of machine learning components and an aggregation layer to generate and synthesize improved protected element predictions with enhanced efficiency and accuracy compared to the traditional or a single model approach. To overcome performance deficiencies with traditional text processing models, the parallel model pipeline incorporates modularized model branches, including regular expression, text-based matching, conditional random field, natural language and/or large language models, and others depending on the domain, that individually extract protected data elements from an input data object. By synthesizing predictions from a plurality of model branches, the parallel model pipeline may identify both direct and indirect expressions of protected information across a wide range of input data object types, formats, and privacy criteria. By doing so, the parallel model pipeline enables improved predictions that, unlike traditional techniques, may handle diverse document structures and content without sacrificing accuracy.

Some embodiments of the present disclosure leverage encryption and decryption processes that addresses technical challenges inherent in maintaining the security and accessibility of documents within a digital environment uniquely susceptible to information attacks. To do so, the encryption and decryption processes implement an encryption algorithm that generates encrypted element representations for protected data elements detected from an input data object by the pipeline discussed herein. The encrypted element representations may be linked to anonymized privacy tags, which allows for the creation of tagged data objects where sensitive information is replaced with anonymized privacy tags, while still preserving the ability to decrypt and recover the original information when authorized by a data access right rule. By doing so, the encryption and decryption processes of the present disclosure enable the autonomous encryption of text to facilitate a more robust and scalable approach to handling sensitive data across various applications and use cases.

Examples of technologically advantageous embodiments of the present disclosure include improvements to the functioning of a computers that improve the way a computer de-identifies, stores, transmits, and retrieves data in memory. For instance, embodiments of the present disclosure modify current encryption protocols to produce a new, deidentified data structure that, unlike traditional deidentified data structures, allows for data anonymization with dynamic decryption. Moreover, embodiments of the present disclosure implement new, parallel models that enable the identification of both direct and indirect identifiers (e.g., potentially identifying information), as opposed to merely direct identifiers of protect information, to improve data security over traditional data security tools that are tailored to previously identified, direct identifiers. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

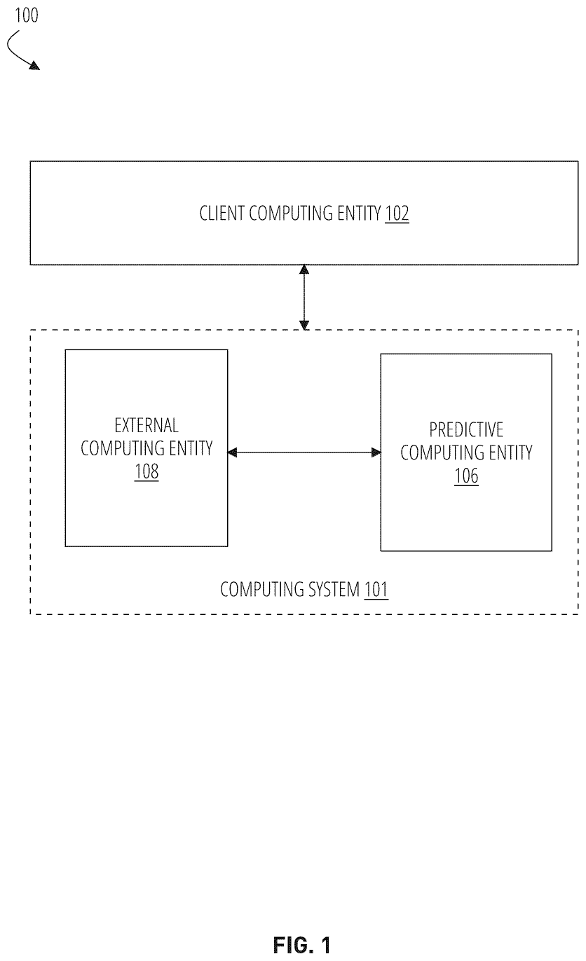

FIG. 1 depicts a block diagram of an example architecture 100 in accordance with some embodiments of the present disclosure. The architecture 100 includes a computing system 101 configured to receive data, such as input data objects, and/or the like, and/or communications, such as decryption requests, and/or the like, from client computing entities 102, process the data and/or communications according to a de-identification process, and provide responses to the client computing entities 102. The example architecture 100 may be used in a plurality of domains and not limited to any specific application as disclosed herewith. The plurality of domains may include healthcare, industrial, manufacturing, computer security, to name a few.

In accordance with various embodiments of the present disclosure, one or more machine learning models may be trained to generate predictive outputs and/or other machine learning model outputs. The models may be adapted to a de-identification process that may be configured to autonomously transform input data objects to tagged data objects. Some techniques of the present disclosure may adapt traditional models to a cohesive framework for more efficiently handling portions of the de-identification process, such as protected element identification, classification, and extraction.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., data processing techniques, encryption techniques, decryption techniques) described herein. The external computing entities 108, for example, may include and/or be associated with one or more entities that may be configured to receive, transmit, store, manage, and/or facilitate datasets, such as various datastores, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

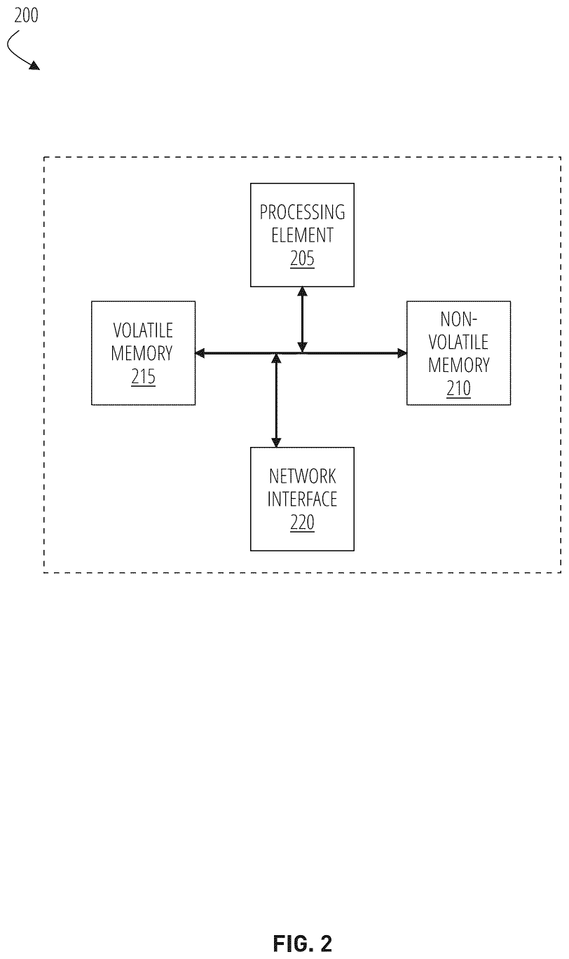

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

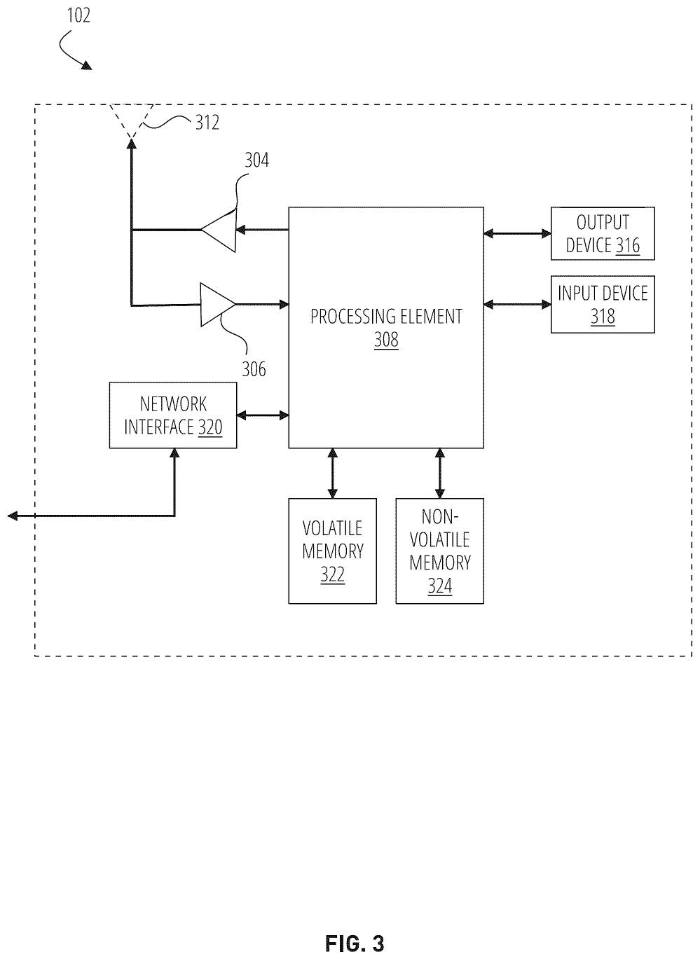

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer functionality. In particular, systems and methods are disclosed herein that implement machine learning and encryption techniques to improve computer and data security while preserving data accessibility where needed for various downstream computing tasks, including machine learning training, among others. By doing so, the machine learning and encryption techniques of the present disclosure enable improved autonomous document processing, storage, and maintenance that, when executed on a computer, improves computer security. This, in turn, may improve the functionality of a computer with respect to various computing tasks, including data security, machine learning training, network communication, and the like.

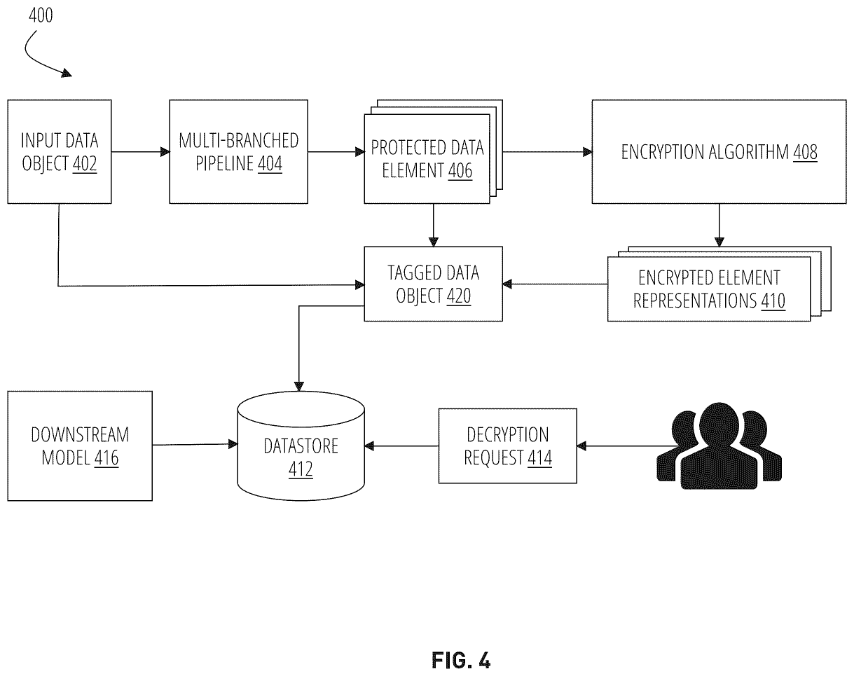

FIG. 4 depicts a dataflow diagram 400 of a de-identification process in accordance with some embodiments of the present disclosure. The de-identification process may be performed when ingesting an input data object 402 with sensitive information to securely store the input data object 402 within a digital environment, such as a datastore 412 located on any computing device, without exposing the sensitive information to malicious parties. The de-identification process improves data security by transforming the input data object 402 to a tagged data object 420 that obfuscates protected data elements 406 with anonymized term representations. In this way, the de-identification process enables the secure storage and transfer of the non-sensitive text within an input data object 402 in any datastore 412 and across any computing entity regardless of their security capabilities without diminishing the readability of the document and while employing reversable encryption for the protected portions of the document. Moreover, the tagged data object 420 may include encrypted element representations 410 that, in some examples, may be locally stored with the non-sensitive text, which allows for the selective and temporary repopulation of sensitive information within the tagged data object 420. By storing the encrypted element representations 410 locally, within the tagged data object 420, the de-identification process enables a local repopulation of the tagged data object 420 without requiring access to external data sources. By doing so, the de-identification process improves the separability and transferability of the encrypted information, as well as decryption speeds and processing requirements, relative to traditional data encryption techniques.

In some embodiments, an input data object 402 is received for processing (e.g., as a pre-processing step of document ingestion) to a datastore 412. The input data object 402 may include a text-based document that includes protected information that may directly and/or indirectly impact a user's privacy. An input data object 402 and/or the protected information therein may depend on the information domain. For instance, in a healthcare domain, an input data object 402 may include a medical record, an insurance claim form, or any other document that includes sensitive medical data, such as protected health information (PHI) as defined by HIPAA regulations, which may include direct and/or indirect identifiers associated with an individual and/or confidential information. such as lab results, and/or the like. In other examples, an input data object 402 may include insurance documents, subscription documents, financial documents, and/or the like that each include overlapping and/or different types of sensitive information. In some examples, an input data object 402 may be input to a de-identification system to enable the duplication and long-term storage of a version of the input data object 402 within a computing environment without exposing the sensitive information therein to a network.

An input data object 402 may include any of a plurality of different forms of information, including digital text files, scanned images, handwritten notes that have been digitized, audio recordings, video files, structured data sets, and/or the like. These various forms of input data objects may require different processing techniques, such as speech-to-text conversion for audio files or data parsing for structured datasets, before applying privacy protection measures of the present disclosure. By way of example, optical character recognition (OCR) may be applied to extract text from image-based documents to generate a text-based input data object. For instance, an input data object 402 may include machine-readable text converted, using OCR, from a scanned image-based documents. The OCR process, for instance, may leverage one or more computer vision and/or machine learning models trained on domain-specific datasets of image and text samples to convert images to text for a particular information domain.

Once received (and/or converted), the input data object 402 may be processed, using one or more techniques of the present disclosure before being stored in a datastore 412, such as one or more relational databases, document-oriented databases, cloud databases, and/or the like, for further processing and analysis. By doing so, an input data object 402 may be processed by a dedicated document management software that may securely store, retrieve, and process sensitive files while maintaining data integrity and access controls.

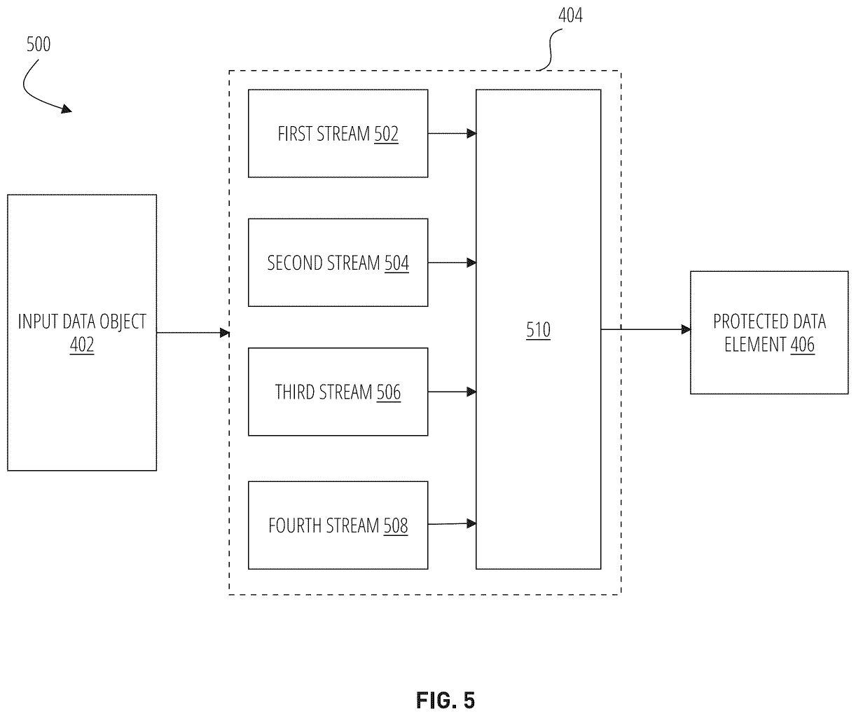

In some embodiments, a plurality of protected data elements 406 is detected and/or extracted from the input data object 402 based on privacy criteria. In some examples, each protected data element 406 may be detected and/or extracted using a parallel model pipeline 404, which is described in further detail with reference to FIG. 5.

In some embodiments, protected data element 406 is a data element within an input data object 402 that satisfies privacy criteria. A protected data element 406 may include a text segment, an image segment, a video clip, and/or any other data type that is directly protected by privacy criteria and/or indirectly protected by privacy criteria. For instance, a protected data element 406 may include a wide range of sensitive data, including both direct and indirect identifiers as defined by privacy standards, such as Health Insurance Portability and Accountability Act (HIPAA) Safe Harbor standards, and/or the like. Example element may reflect ages, contact information (e.g., phone numbers, fax numbers, email addresses), dates (e.g., exact dates (May 20, 2024, etc.), relative dates (two days before, etc.)), physical and/or virtual locations, names of individuals and/or organizations, various identification numbers (e.g., social security numbers, medical record numbers, device IDs), web-related identifiers, such as URLs and IP addresses, and/or the like.

The presence of protected data elements 406 within an input data object 402 presents several technical challenges to traditional document management systems. To address these challenges, traditional document processing techniques handle the presence of protected data elements 406 within an input data object 402 by preventing the storage and/or the accessibility of the input data object 402. This prevents use of the input data object 402 for post processing techniques, such as machine learning training (e.g., for downstream models 416) and/or the like and is an imperfect solution to document privacy as traditional document processing techniques are limited to the identification of direct identifiers of protected information and fail to identify indirect identifiers of protected information. The de-identification process addresses these challenges by applying a parallel model pipeline, including regular expressions, text matching, conditional random fields, language models, and/or the like, to detect and classify protected data elements 406 within the input data object 402. Once detected, using the techniques of the present disclosure, the protected data elements 406 may be anonymized, encrypted, and/or replaced with privacy-preserving tags (e.g., anonymized privacy tags) to create a de-identified version (e.g., tagged data object) of the input data object 402 that maintains compliance with privacy criteria while preserving the input data object's utility for authorized purposes.

In some embodiments, privacy criteria define one or more domain-specific standards, regulations, and/or the like that govern the protection of sensitive information within an information domain. The privacy criteria may provide a framework for identifying protected data elements 406 from an input data object 402 and/or handling procedures for the protected data elements 406. Privacy criteria, for example, may be domain specific. For instance, in a healthcare domain, privacy criteria may include standards such as HIPAA regulations, and/or the like. The privacy criteria may be embodied by various data structures, including predefined rulesets (e.g., regex rules), modeled correlations (e.g., trained machine learning models), and/or the like.

In some embodiments, up to each protected data element 406 extracted from the input data object 402 corresponds to a privacy type. A privacy type may describe a category and/or context in which a protected data element 406 is classified as protected. Privacy types may include term labels for protected data elements 406 that enable more nuanced handling of different kinds of sensitive information. For example, privacy types may include categories such as personal information, temporal information, location data, identification numbers, and/or the like.

In some examples, a privacy type may be assigned to a protected data element 406 to enable the application of different encryption techniques based on the nature of the information. For instance, dates may be handled differently from names or identification numbers. In some examples, as described herein, the privacy types may facilitate the creation of more informative anonymized privacy tags that may preserve some context within a tagged text data object 420 while protecting the underlying protected data element 406. In some examples, the privacy type may be assigned by the parallel model pipeline (and/or stream thereof) used to extract the protected data element 406. In addition to techniques described in the parallel model streams, one or more machine learning classifiers, such as support vector machines (SVMs), neural networks, and/or the like, may be trained to automatically assign privacy types to identified protected data elements 406 based on context and/or features of a protected data element 406.

In some embodiments, a tagged text data object 420 is generated from the input data object 402 by replacing up to each of the plurality of protected data elements 406 with a respective anonymized privacy tag that identifies a privacy type of the respective protected data element 406. In some embodiments, the tagged data object 420 is a transformation of an input data object 402 that selectively obfuscates protected data elements 406 within the input data object 402. By way of example, a tagged data object 420 may include a protected version of the input data object 402 in which sensitive information is obscured, anonymized, removed, and/or the like, while maintaining the overall structure and non-sensitive content of the input data object 402. A tagged data object 420 may be represented as a natural language text document, structured text file (e.g., XML, JSON, etc.), video, image, and/or the like, in which protected data elements 406 of the input data object 402 are replaced with anonymized privacy tags. In this manner, a tagged data object 420 may include a de-identified version of the input data object 402 that may be securely shared, analyzed, and/or processed without risking exposure of sensitive information. This, in turn, allows for the retention and use of tagged data objects 420 for various post processing techniques, including machine learning model training (e.g., for downstream models 416), and/or the like.

In some embodiments, an anonymized privacy tag is a data element (e.g., unit of text, section of video, portion of an image) that replaces a protected data element 406 within a tagged data object 420. For example, the anonymized privacy tag may include a textual representation, token, and/or the like, that may identify a placement of a protected data element 406 within an input data object 402 without exposing the sensitive information of the protected data element 406. To do so, in some examples, the anonymized privacy tag may include a privacy type delimiter, such as <Name>, <Date_Birth>, <Age>, and/or the like, that replaces the sensitive information of a protected data element 406 with an indication of the privacy type of the protected data element 406. The privacy type delimiter, for example, may comprise a static representation of a privacy type and/or a dynamic privacy representation (e.g., generated by an LLM, randomly selected from a lookup table). In this manner, an anonymized privacy tag may link a location within a tagged data object 420 to an encrypted element representation 410 of the protect data element 406 to allow for the local decryption of the input data object 402 from the tagged data object 420 by authorized entities (e.g., users, computer processes).

In some embodiments, an encrypted element representation 410 is generated for up to each of the protected data elements 406, all of the protected data elements collectively, or all of the protected data elements of a same privacy type. The encrypted element representations 410, for example, may be generated using an encryption algorithm 408. For example, an encrypted element representation 410 of a protected data element 406 may include an encrypted string corresponding to the protected data element 406 and/or one or more privacy type delimiters that correspond to the privacy type of the protected data element 406. The encrypted string may be generated by applying an encryption algorithm 408 to the protected data element 406.

In some embodiments, an encrypted element representation 410 is an encapsulated encryption of a protected data element 406. For example, an encrypted element representation 410 may include (1) an encrypted string that is output of applying an encryption algorithm 408 to a protected data element 406 and (2) one or more privacy type delimiters that correspond to an anonymized privacy tag. In some examples, an encrypted element representation 410 may include a starting delimiter and a terminating delimiter. The encrypted element representation 410, for example, may include an encrypted string that is placed between the starting delimiter and terminating delimiters. By way of example, an encrypted element representation 410 for a privacy type “Name,” may be represented as <NAME_START>123456789abcdef<NAME_END> where 123456789abcdef is an encrypted string of the protected name extracted from the input document 402, <NAME_START> is a starting delimiter and <NAME_END> is an ending delimiter. In some examples, the privacy type delimiters <NAME_START> and <NAME_END> may correspond to a <Name> anonymized privacy tag that designates a placement of the protected name extracted within the tagged data object 420. In this manner, an encrypted element representation 410 may include a combination of cryptographic techniques with data structuring methods to convert a protected data element 406 into an encrypted string with context about the nature of the encrypted data. This allows for selective decryption and processing of protected data elements 406 based on user authorization levels or specific privacy criteria. Moreover, in an additional or alternate example, this representation may be embedded in the document as hidden text associated with an anonymized term generated by a machine-learned model for that privacy type. For example, the anonymized term may comprise an anonymized replacement of the protected data element that maintains a readability of the tagged data object without exposing the protected data element. The anonymized term may be selected (e.g., randomly) from a lookup table for a particular privacy type, generated by an LLM, and/or the like to replace the protected data element with a contextually relevant replacement.

In some examples, the encryption algorithm 408 may be based on the privacy type of the protected data element 406. For example, a subset of the plurality of protected data elements 406 may be determined that correspond to the privacy type of the protected data element 406. Each protected data element 406 of the subset of protected data elements 406 may be concatenated to generate a concatenated term subset in which each protected data element 406 is separated by a delimiting character. The encrypted element representation 410 may be generated by encrypting the concatenated term subset.

More particularly, one encrypted element representation 410 may be generated for each privacy type. For instance, each protected data element 406 of a particular privacy type may be grouped into a set of protected data elements 406 for the privacy type. As an example, data values, such as “2020 Jan. 1,” “January 1st,” “three days ago,” and/or the like may be grouped into a date privacy type group. In some examples, the set of protected data elements 406 may be grouped by concatenating the terms in a concatenated term subset, in which each protected data element 406 is separated by a delimiter. For example, each date phrase within the input data object 402 may be joined with a tab character (and/or other uncommon characters, such as “∥,” etc.) like “2020 Jan. 1<TAB>January 1st<TAB>three days ago” in the order of appearance in the input data object 402. By doing so, encryption speeds may be improved at the cost of less computing resources by selectively applying an encryption algorithm 408 once per privacy type, rather than individually applying the encryption algorithm 408 to each instance of a privacy type (e.g., on a protected element by element basis).

In some embodiments, the encryption algorithm 408 is an algorithm used to secure protected data elements 406 within a document. An encryption algorithm 408 may be designed to transform plaintext (e.g., readable data) into ciphertext (e.g., encrypted data). In some examples, the ciphertext may be encrypted and/or decrypted using a cryptographic key corresponding to the cipher text. In this manner, the encryption algorithm 408 may be applied to protected data elements 406 to generate encrypted strings to secure sensitive information within an input data object 402 in a way that renders it unreadable unless decrypted (e.g., using a corresponding private key). This allows for secure storage and transmission of tagged data objects while maintaining the ability to recover the original information when authorized.

An encryption algorithm 408 may include one or more encryption techniques, such as symmetric key algorithms (e.g., Advanced Encryption Standard (AES)), asymmetric key algorithms (e.g., Rivest-Shamir-Adleman (RSA)), and/or the like. By way of example, the encryption algorithm 408 may include a symmetric encryption technique (e.g., AES-128, AES-256) that applies a cryptographically-generated key (e.g., using a key derivation function (KDF)) to encrypt and/or subsequently decrypt a protected data element 406 (and/or concatenated term subset) upon authentication (e.g., using hash-based message authentication code (HMAC)). In addition, or alternatively, an encryption algorithm 408 may include an asymmetric encryption technique that applies a public key to encrypt a protected data element 406 that corresponds to a private key used to decrypt an encrypted string of an encrypted element representation 410. In some examples, an encryption algorithm 408 may include one or more homomorphic encryption schemes that allow computations to be performed on encrypted data without decrypting it first and/or format-preserving encryption techniques, which encrypt data in a way that maintains the format of the original data.

In some embodiments, a private key is a cryptographic key used to decrypt (and/or encrypt) an encrypted string of an encrypted element representation 410. A private key, for example, may include a cryptographic key that is assigned to one or more entities (e.g., users, downstream models 416) that are authorized to access one or more portions of encrypted element representations. In some examples, a private key may be used to encrypt (e.g., in a symmetric encryption) a protected data element 406 to generate the encrypted string and then decrypt the encrypted string to reproduce the protected data element 406. In addition, or alternatively, a private key may correspond to a public key used to encrypt (e.g., in an asymmetric encryption) a protected data element 406 to generate the encrypted string. In such a case, a private key may be configured to decrypt any encryption string generated using a corresponding public key.

In some examples, an encryption algorithm 408 may leverage a set of private and/or public keys to encrypt protected data elements 406 of different privacy types. The protected data elements 406 may be encrypted with different private and/or public keys to prevent one private key from decrypting all encrypted element representation 410 associated with a tagged data object 420. In this manner, one or more private keys may be assigned to an entity, based on an entity's priority level, to allow segmented access to one or more protected data elements 406 of different privacy types within a tagged data object 420.

In some examples, an encryption algorithm 408 may leverage a multiple lock approach in which a private key is divided into a subset of secret keys. For example, instead of a single private key, the private key may be split into multiple parts, such that a private key “AAAA1111” may be split into a first “AAAA” secret key and a second “1111” secret key in a two-part split (any number of splits could be used to increase security at the expense of time). Each secret key may be stored in different locations and/or may require separate authentication by users having different privileges to access the respective keys, such that an entity with access to a first secret key may not have access to the second secret key and vice versa. For example, user(s) provisioned a role with permission to access the first secret key may be denied provision of a role with permission to access the second key. When an encryption algorithm 408 is applied, each of the entities with access to the secret keys that make up the private key may send the keys to the encryption algorithm 408, which encrypts or decrypts a protected data element 406 using a private key generated by concatenating a combination of the received secret keys in an order that may be separately specified at the time the secret keys are generated from the private key. The encryption algorithm 408, for example, may merge the multi-split secret keys to restore the full single private key, then apply the private key to encrypt or decrypt the protected data element 406. In some examples, decryption may require successful authentication by each user associated with one of the secret keys before the secret keys are transmitted and merged. By doing so, multiple different access roles may be enforced to both encrypt and decrypt a protected data element 406 within a tagged data object 420.

In some embodiments, a priority level is an access level assigned to an entity that determines an ability to request and receive decrypted information from a tagged data object 420. Priority levels may be used to implement a granular access control system, ensuring that sensitive information is only revealed to authorized parties based on their specific needs and/or permissions. Priority levels may be structured in various ways, including numeric scales (e.g., 1-5, with 5 being the highest priority), named tiers (e.g., “Low”, “Medium”, “High”, “Admin”), role-based levels (e.g., “Researcher”, “Clinician”, “Data Administrator”), and/or the like. Each priority level may be associated with specific permissions, such as types of protected data elements 406 that may be decrypted (e.g., dates only, all except names), volume of data that may be decrypted in a given time period, requirements for additional authentication or approval for decryption requests, and/or the like. In some examples, each priority level may correspond to one or more cryptographic keys that may be provided to an entity to access a portion of protected data elements 406 within a tagged data object 420.

By way of example, a set of cryptographic keys may be maintained (e.g., issued, stored, provided) by a security manager service (e.g., a cloud-based secret manager, enterprise key datastore). In some examples, the security manager service may maintain the set of cryptographic keys in association with one or more priority levels. For example, up to each of a plurality of key subsets of the set of cryptographic keys may be assigned to a respective priority level of a set of defined priority levels. In addition, or alternatively, the security manager service may associate up to each of a set of user profiles with one or more of the set of defined priority levels. In some examples, the security manager service may be configured to authenticate an identity of a user through one or more authentication protocols, such as a username password pair, two factor authentication, and/or the like. In response to authenticating a user, the security manager service may issue and/or otherwise allow access to a subset of the set of cryptographic keys based on the user's associated priority levels. In addition, or alternatively, in response to authenticating the user, the security manager service may apply the cryptographic key to a tagged data object 420 and/or one or more encrypted element representations 410 thereof without exposing the cryptographic key to the user.

In some embodiments, a plurality of encrypted element representations 410 respectively corresponding to the plurality of protected data elements 406 extracted from the input data object 402 is inserted to a portion of the tagged data object 420. For example, the portion of the tagged data object 420 may include a termination portion of the tagged data object 420 after the content of the tagged data object 420 concludes. An encrypted element representation 410 may be inserted at a position within a sequence of encrypted element representations 410 respectively corresponding to the plurality of protected data elements 406 based on a location of the protected data element 406 within the input data object 402. For example, each encrypted element representation 410 may be inserted according to the order in which they occur within the tagged data object 420.

For example, a plurality of encrypted element representations 410 may be concatenated within a portion of a tagged data object 420. By way of example, a plurality of encrypted element representations 410 for a plurality of protected data elements 406 extracted from an input data object 402 may be appended at the end (e.g., a terminating portion) of the tagged data object 420. In this manner, encrypted strings for each of the protected data elements 406 within the input data object 402 may be stored, with delimiters identifying a placement of the encrypted strings, with the deidentified text data from the input data object 402.

In some embodiments, the tagged data object 420 is stored in a datastore 412. Due to the local storage of encrypted element representations 410 within the tagged data object 420, the datastore 412 may include local, cloud-based, and/or distributed storage environment without impacting the security and/or accessibility of information within the tagged data object 420.

In some embodiments, a decryption request 414 is received that identifies the tagged data object 420. A decryption request 414 may be a request to decrypt a tagged data object 420 to recover the original protected data elements 406 that were encrypted during the de-identification process. A decryption request 414 may include an identifier of a tagged data object 420 to be decrypted, one or more authorization credentials (e.g., cryptographic keys), and/or one or more protected data elements 406 and/or privacy type identifiers that identify one or more encrypted element representations 410 for decryption (e.g., only dates, or all protected data elements).

In some embodiments, responsive to the decryption request, one or more of the protected data elements 406 are overlayed over one or more anonymized privacy tags within the tagged data object 420. For example, the one or more encrypted element representations 410 corresponding to the one or more protected data elements 406 may be decrypted. The anonymized privacy tags corresponding to the one or more encrypted element representations 410 may be identified based on the privacy type of the protected data elements. The protected data elements 406 may be overlayed over the identified anonymized privacy tags.

In some examples, responsive to the decryption request 414, one or more cryptographic keys may be retrieved (e.g., via the security manager service) that are authorized for use based on authentication credentials associated with a successfully authenticated decryption request 414. The one or more cryptographic keys may be applied to one or more encrypted element representations 410 (e.g., stored within a portion of the tagged data object 420) to decrypt protected data elements 406 from the encrypted element representations. The protected data elements 406 may be overlayed at a position of a corresponding anonymized privacy tag within the tagged data object 420 to temporarily provide visibility to sensitive information within the input data object 402 to authorized entities (e.g., users, services). In some examples, the decryption request 414 may include at least a portion of a cryptographic key and the protected data element 406 may be decrypted using the cryptographic key. In some examples, the decryption request 414 and/or the cryptographic key may be associated with a priority level and a portion of the plurality of data elements may be decrypted based on the priority level. By way of example, the decryption request may comprise authentication credentials for an entity (e.g., user, service) that authenticate an entity associated with a particular priority level.

FIG. 5 depicts an operational example 500 of a parallel model pipeline 404 in accordance with some embodiments of the present disclosure. As shown in the operational example 500, the parallel model pipeline 404 may receive an input data object 402 as input and may generate, through a set of parallel processing operations, a plurality of protected data elements 406 extracted from the input data object 402. As shown, the parallel model pipeline 404 may include a parallel architecture that defines a set of branches of complementary models that may be used separately, in combination, and/or in parallel. The modular, parallel architecture enables the modification (e.g., addition, subtraction) of different models to the parallel model pipeline 404 to improve the overall performance of the model with respect to both direct and indirect identifiers of protected information. By way of example, by separating up to each of a set of models into modular processing streams, the modular, parallel architecture of the parallel model pipeline 404 enable the modification, removal, and/or addition of different models to the parallel model pipeline 404 without impacting models encapsulated in different processing streams. Data elements of the input data object 402 may be processed, using one or more of the plurality of parallel processing streams, to generate a set of protected data element predictions that may be aggregated, via an aggregation layer, to detect a comprehensive set of protected data elements 406 from the input data object 402. By doing so, the parallel architecture of the parallel model pipeline 404 may improve the comprehensiveness of protected data element extraction to improve the accuracy and reliability of autonomous de-identification techniques.

In some embodiments, parallel model pipeline 404 defines an ensemble of prediction models that are collectively configured to predict whether a data element is a protected data element 406 based on one or more different constraints. The parallel model pipeline 404 may be configured to combine a plurality of specialized models, each configured to handle different aspects or execute different techniques for identifying sensitive information, to generate comprehensive term predictions capable of identifying protected data elements 406 reflective of both direct and indirect identifiers of sensitive information. A parallel model pipeline 404 may include a parallel (and/or sequential) processing architecture in which each processing stream of the pipeline may be implemented as a separate machine learning or rule-based model, such as regular expression(s), text matching algorithms, conditional random field(s), deep learning model(s) like LSTM (long short-term memory) network(s) and/or neural network(s), transformer-based model(s), and/or the like. In some examples, the parallel model pipeline 404 may be implemented using a distributed computing framework that allows for the parallel (or sequential) execution of different model streams to generate a plurality of protected data element predictions.

In some examples, the parallel model pipeline 404 may process up to each data element of the input data object 402 with up to each stream of the parallel model pipeline 404. In addition, or alternatively, the parallel model pipeline 404 may include an adaptive selection mechanism configured to route a subset of data elements to one or more of the model streams or a sequence of components of a model stream based on one or more data elements and/or input data object attributes. By way of example, the parallel model pipeline 404 may dynamically determine one or more model streams to use based on the characteristics (e.g., format type, data source, content data type) of the input data object 402, such a document type, and/or the like. In some examples, a data element may be processed in a sequential manner in which each model stream is applied until a stopping condition is reached. A stopping condition, for example, may include an indication that a protected element prediction reaches or exceeds a prediction threshold (e.g., 0.75, 0.8, 0.9). In this manner, less processing and time intensive streams may be applied to filter out protected data elements 406 with known correspondences (e.g., exact text matched via a regular expression) to protected data elements 406 from analysis by more processing and time intensive streams.

In some embodiments, a first subset of protected element predictions is generated for at least a first subset of data elements extracted from the input data object 402 using a first stream 502 of a parallel model pipeline 404. The first stream 502, for example, may include a first component of the parallel model pipeline 404 that may be applied (e.g., as an initial detection step) before subsequent streams in the parallel model pipeline 404.

In some embodiments, the first stream 502 comprises a regular expression branch. For instance, the regular expression branch may include one or more regular expressions configured to identify protected data elements 406 based on defined pattern-matching rulesets. The pattern-matching rulesets, for example, may be applied to candidate terms to identify specific sequences of characters within text. A regular expression, for example, may include a finite state machine (FSM), formal language processing rulesets, and/or the like. In some examples, first stream 502 may be configured to maintain a database of pre-compiled regex patterns corresponding to different types of protected data elements, which may be efficiently applied to input text (e.g., a candidate term) to identify a matching protected data element 406 based on a syntactic and/or structural similarity between the input text and the matching protected data element. In this way, a regular expression model may present improved predictive capabilities for structured and/or semi-structured privacy types that follow predictable patterns, such as social security numbers, phone numbers, email addresses, and/or the like. In some examples, the regular expression model may implement one or more fuzzy matching techniques to account for slight variations in protected data element formats. In addition, or alternatively, a regular expression model may leverage dynamic regex generation, where the model learns and generates new regex patterns based on observed data patterns, allowing for adaptive protection against evolving types of sensitive information.

In some embodiments, a second subset of protected element predictions is generated for at least a second subset of data elements extracted from the input data object 402 using a second stream 504 of the parallel model pipeline 404. The second stream 504, for example, may include a text-based matching branch. The text-based matching branch may include one or more text matching models configured to identify protected data elements 406 based on a textual similarity between a candidate term and a set of historical or defined protected data elements. A text-based matching model, for example, may generate a protected element prediction based on a textual comparison (e.g., as opposed to formatting comparisons of the regular expression model) between input text (e.g., candidate term) against one or more predefined lists and/or dictionaries of historical protected data elements. A text-based matching model may include one or more string-matching algorithms, such as Aho-Corasick for multiple pattern matching, and/or the like. In some examples, the text-based matching model may include one or more adaptable lookup tables, such as suffix trees for fast dictionary lookups. In some examples, the adaptable lookup tables may be dynamically updated after each iteration of the parallel model pipeline 404. In this manner, the more efficient text-based matching model may incrementally replace expensive machine learning prediction operations as the parallel model pipeline 404 is used over time by learning protected data elements 406 from more complex branches of the parallel model pipeline 404.

In some embodiments, a third subset of the of protected element predictions is generated for at least a third subset of a plurality of data elements extracted from the input data object 402 using a third stream 506 of the parallel model pipeline 404. The third stream 506, for example, may include a conditional random field branch that uses conditional random field techniques to identify protected data elements. For example, a conditional random field model may include a statistical model (e.g., probabilistic graphical model where term features are represented by connected nodes) that represents one or more dependencies between a protected data element, its context, and/or other protected data element(s). The conditional random field model may be trained to learn the dependencies using a labeled training dataset of documents with annotated protected data elements. In some examples, the regular expression and/or text-based matching models may form feature extraction pipelines that may be used to extract features for generating one or more dependencies between protected data elements 406 from a plurality historical input data objects. In some examples, the conditional random field model may be configured to generate protected data element predictions based on local term features and the sequential nature of terms within an input data object. In this manner, the conditional random field model may be effective at capturing context and dependencies between adjacent words, making this branch well-suited for identifying protected data elements 406 that may be ambiguous when considered in isolation.

In some embodiments, a fourth subset of protected element predictions is generated for at least a fourth subset of a plurality of data elements extracted from the input data object 402 using a fourth stream 508 of the parallel model pipeline 404. The fourth stream 508, for example, may include a language model branch that uses semantic matching techniques to identify protected data elements. A language model branch, for example, may leverage various language models, such as those based on transformer architectures (e.g., bidirectional encoder representations from transformers (BERT), generative pre-trained transformers (GPT)), neural network(s), encoder(s) (which may include neural network and/or transformer-based model(s)) among others, and/or similarity component(s) (e.g., clustering and/or embedding space distance determination component(s)), neural network(s), and/or the like that use the semantic context of a candidate term within an input data object to predict the likelihood that a term is a protected data element. The language model branch may process input text (e.g., a candidate terms) to generate contextual embeddings that may be used to classify whether the input text is a protected data element 406 based on an embedding similarity (e.g., cosine similarity) between the contextual embeddings and one or more protected data element embeddings. In this manner, a language model branch may identify indirect sensitive information that semantically corresponds to historical protected data elements without syntactically matching the historical protected data elements.

In some embodiments, a subset or all of the streams of the parallel model pipeline 404 outputs one or more of a set of protected element predictions for a set of candidate data elements within an input data object 402. A protected element prediction may include an output from one of the streams of the parallel model pipeline 404. A protected element prediction may include a binary and/or probabilistic output (e.g., a logit) that represents a likelihood (e.g., a posterior probability) that a candidate term is a protected data element 406 with respect to one or more privacy criteria. For example, a protected element prediction may include a binary value indicating whether the candidate term is predicted to be a protected data element 406 (“1”) or predicted to not be a protected data element 406 (“0”). In addition, or alternatively, a protected element prediction may include a probability and/or confidence score representing a likelihood (e.g., range from 0-100, 0-1, or that may be unnormalized and that may be normalized into a range) that the term is protected. In some examples, a plurality of protected element predictions may be generated by each stream of the parallel model pipeline 404 (e.g., regular expression stream, text-based matching stream, conditional random field stream, language model stream) for one or more candidate data elements within an input data object 402. The plurality of protected element predictions may serve as intermediate outputs of the parallel model pipeline 404 that may be aggregated by an aggregation layer 510 to generate aggregated outputs reflective of a set of protected data elements 406 within an input data object. The aggregation layer, for example, may synthesize the plurality of protected element predictions using one or more aggregation techniques, such as majority voting, weighted averaging of probabilities, maximum probability across all models, determining a softmax probability distribution of the outcomes and determining the top n probabilities where n is a positive integer or determining the softmaxed values that meet or exceed a threshold, and/or the like, to generate a final set of protected data elements. By doing so, the parallel model pipeline 404 may synthesize protected element predictions from multiple model streams to improve the overall accuracy and robustness of protected element predictions, as different models may excel at identifying different types of protected data elements. In an example using a softmax function and where real values and binary values are both output by the streams, the binary values may be excluded from the softmax determination and used to independently determine a prediction (e.g., a 1 may be determined to be a predicted protected data element and a 0 may be determined to be a non-protected data element) and/or to weight other predictions determined by other streams. For example, a positive output by a binary component (e.g., 1) may be associated with a weight of 1.1 1.25, 1.5, or the like that may be multiplied by the output of another stream associated with the same data element where the output indicates a real value of 0.5 or greater (where the output is normalized to within the range of 0 to 1); whereas a negative (e.g., 0) output by a binary component may be associated with a weight of 1, 0.9, or the like that may be multiplied by an output of another component for the same data element that is 0.49 or less (where the output is normalized between 0 and 1).

For example, an aggregated set of protected element predictions may be generated based on the first subset of protected element predictions, the second subset of protected element predictions, the third subset of protected element predictions, and/or the fourth subset of protected element predictions. The aggregated set of protected element predictions, for example, may be generated by the aggregation layer 510 of the parallel model pipeline 404. In some examples, the parallel model pipeline 404 may include an aggregation layer 510 that implements model aggregation techniques, such as model voting, weighted averaging, and/or the like, to generate aggregated predictions by aggregating the plurality of protected element predictions from the different streams of the parallel model pipeline 404. The aggregated predictions may be output as a set of protected data elements 406 for an input data object 402.

In some examples, the aggregation layer 510 may be trained using one or more supervised training techniques. For instance, the aggregation layer may include a supervised machine learned model (e.g., neural network, decision tree, support vector machine) that is trained to synthesize a set of protected element predictions based on the strengths of each stream of the parallel model pipeline 404. The aggregation layer 510 may be trained (e.g., via a backpropagation of errors) to optimize a loss function (e.g., via gradient decent) that measures a prediction accuracy based on a plurality of labeled training terms (e.g., labeled with a protected or unprotected label). In some examples, the aggregation layer 510 may be trained to output an aggregated prediction and a privacy type for aggregated predictions that identify a protected data element.

In some embodiments, a set of protected data elements 406 is determined based on the aggregated plurality of protected element predictions. For examples, an input data object 402 may be input to the parallel model pipeline 404 to detect a plurality of protected data elements 406 based on the aggregated predictions from each stream of the parallel model pipeline 404. In this manner, the parallel model pipeline 404 may improve the accuracy and robustness of protected data element identification by synthesizing the strengths of different modeling approaches into aggregated element predictions. By doing so, the parallel model pipeline 404 outperforms single model approaches by capturing a wider range of patterns and contexts that indicate the direct and indirect presence of sensitive information.

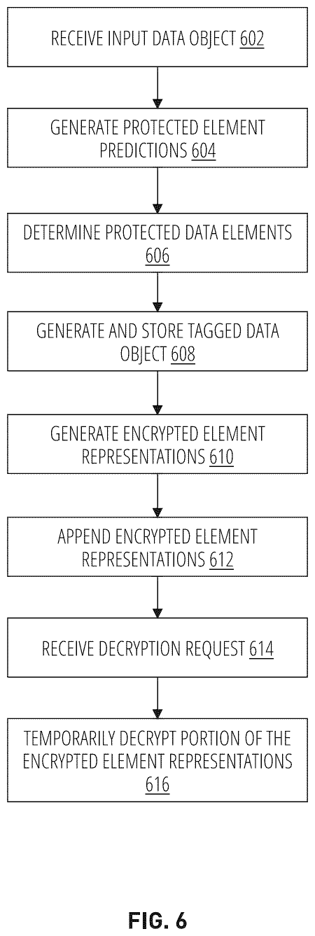

FIG. 6 depicts a flowchart diagram of an example de-identification process 600 in accordance with some embodiments of the present disclosure. The flowchart diagram depicts an encryption and data processing technique that transforms an input data object with sensitive information to a tagged data object that may be securely store, transferred, and locally decrypted in any computing environment. The process 600 may be implemented by one or more computing devices, entities, and/or systems described herein. For example, via the various steps/operations of the process 600, the computing system 101 may leverage the encryption and data processing technique to effectively transform an input data object into a tagged data object that obfuscates protected data elements and locally stores encrypted version of protected data elements. By doing so, the process 600 enables the autonomous de-identification of sensitive information that addresses several technical challenges of traditional encryption techniques by enabling the local decryption of the sensitive information by authorized entities.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at operation 602, receiving an input data object. For example, the computing system 101 may receive an input data object with sensitive information therein.

In some embodiments, the process 600 includes, at operation 604, generating protected element predictions. For example, the computing system 101 may generate, using one or more streams of a parallel model pipeline, a set of protected element predictions. In some examples, up to each of the set of protected element predictions may identify a protected data element and/or a privacy type of the protected data element. For instance, the computing system 101 may generate, using a first stream of a parallel model pipeline, a first subset of protected element predictions for a first subset of a set of data elements extracted from the input data object. In some examples, the first stream may include a regular expression stream. The computing system 101 may additionally or alternatively generate, using a second stream of the parallel model pipeline, a second subset of protected element predictions for the set of data elements. In some examples, the second stream may include a text-based matching stream. The computing system 101 may additionally or alternatively generate, using a third stream of a parallel model pipeline, a third subset of protected element predictions for a set of data elements extracted from the input data object. The third stream may include a conditional random field stream. The computing system 101 may additionally or alternatively generate, using a fourth stream of a parallel model pipeline, a fourth subset of protected element predictions for a plurality of data elements extracted from the input data object. In some examples, the fourth stream may include a language model stream.

In some embodiments, the process 600 includes, at operation 606, determining protected data elements within the input data object. For example, the computing system 101 may determine a protected data element from an input data object based on privacy criteria. In some examples, the computing system 101 may generate an aggregated plurality of protected element predictions based on the first plurality of protected element predictions, the second plurality of protected element predictions, the third plurality of protected element predictions, and/or the fourth plurality of protected element predictions. The computing system 101 may determine the protected data element based on the aggregated plurality of protected element predictions.

In some embodiments, the process 600 includes, at operation 608, generating and storing a tagged data object for the input data object. For example, the computing system 101 may generate the tagged data object from the input data object by replacing the protected data element with an anonymized privacy tag that identifies a privacy type of the protected data element. The computing system 101 may store the tagged data object within a datastore.

In some embodiments, the process 600 includes, at operation 610, generating encrypted element representations for the protected data elements. For example, the computing system 101 may generate, using an encryption algorithm, an encrypted element representation of the protected data element. For instance, the encrypted element representation may include an encrypted string corresponding to the protected data element and a privacy type delimiter that corresponds to the privacy type of the protected data element. In some examples, an encryption algorithm may be based on the privacy type of the protected data element.

In some examples, the protected data element is one of a plurality of protected data elements within the input data object. The computing system 101 may determine a subset of the plurality of protected data elements that correspond to the privacy type of the protected data element. The computing system 101 may concatenate each protected data element of the subset of protected data elements to generate a concatenated term subset in which each protected data element is separated by a delimiting character. The computing system 101 may generate the encrypted element representation by encrypting the concatenated term subset.

In some embodiments, the process 600 includes, at operation 612, appending the encrypted element representation to the tagged data object. For example, the computing system 101 may insert the encrypted element representation to a portion of the tagged data object. For instance, the protected data element may be one of a plurality of protected data elements within the input data object and the portion of the tagged data object may be a terminating portion of the tagged data object. The encrypted element representation may be inserted at a position within a sequence of encrypted element representations respectively corresponding to the plurality of protected data elements based on a location of the protected data element within the input data object.

In some embodiments, the process 600 includes, at operation 614, receiving a decryption request. For example, the computing system 101 may receive a decryption request that identifies the tagged data object. In some examples, the decryption request includes a private key (and/or a secret key).

In some embodiments, the process 600 includes, at operation 616, temporarily decrypting a portion of the encrypted element representation. For example, the computing system 101 may, responsive to the decryption request, overlay the protected data element over an anonymized privacy tag within the tagged data object. For instance, the computing system 101 may decrypt the encrypted element representation. For instance, the computing system may decrypt the protected data element of the encrypted element representation using a private key (and/or a secret key) from the decryption request.

The computing system 101 may identify the anonymized privacy tag based on the privacy type of the protected data element and overlay the protected data element over the anonymized privacy tag to temporarily decrypt a portion of the encrypted element representation. For instance, the protected data element may be one of a plurality of protected data elements within the input data object. The decryption request may be associated with a priority level and a portion of the plurality of protected data elements may be decrypted based on the priority level.

Some techniques of the present disclosure enable the generation of action outputs that may be performed to initiate one or more real world actions to achieve real-world effects. The techniques of the present disclosure may be used, applied, and/or otherwise leveraged to transform input data objects to tagged data objects that may be used for one or more downstream processes without exposing the sensitive information of the input data object. These downstream processes, for example, may trigger action outputs (e.g., through control instructions) to automate computer performance actions, clinical actions (e.g., filling shipping information for a prescription order, initiate order for lab, contact patient, train machine-learned model based on clinical, but not personal information), and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may include actions that may be based on an information domain. An information domain may include any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising determining, by one or more processors and a model pipeline, a protected data element from an input data object based on privacy criteria; generating, by the one or more processors, a tagged data object from the input data object by replacing the protected data element with an anonymized privacy tag that identifies a privacy type of the protected data element; generating, by the one or more processors and using an encryption algorithm, an encrypted element representation of the protected data element; inserting, by the one or more processors, the encrypted element representation to a portion of the tagged data object; and storing, by the one or more processors, the tagged data object.

Example 2. The computer-implemented method of any of the preceding examples, wherein the encrypted element representation comprises an encrypted string generated from the protected data element and a privacy type delimiter associated with the privacy type of the protected data element.

Example 3. The computer-implemented method of any of the preceding examples, wherein the protected data element is one of a plurality of protected data elements within the input data object, the portion of the tagged data object is a terminating portion of the tagged data object, and the encrypted element representation is inserted at a position within a sequence of encrypted element representations respectively corresponding to the plurality of protected data elements based on a location of the protected data element within the input data object.

Example 4. The computer-implemented method of any of the preceding examples, wherein determining the protected data element comprises generating, using a first stream of a parallel model pipeline, a first subset of protected element predictions for a first subset of a set of data elements detected in the input data object by a regular expression stream of the parallel model pipeline; generating, using a second stream of the parallel model pipeline, a second subset of protected element predictions for a second subset of the set of data elements by a text-based matching stream of the parallel model pipeline; generating, using a third stream of the parallel model pipeline, a third subset of protected element predictions for a third subset of the set of data elements by a conditional random field stream of the parallel model pipeline; generating, using a fourth stream of the parallel model pipeline, a fourth subset of protected element predictions for a fourth subset of the set of data elements by a language model stream of the parallel model pipeline; generating an aggregated set of protected element predictions based on the first subset of protected element predictions, the second subset of protected element predictions, the third subset of protected element predictions, and the fourth subset of protected element predictions, wherein the protected data element is part of the set of protected term predictions.

Example 5. The computer-implemented method of any of the preceding examples, wherein the encryption algorithm is based on the privacy type of the protected data element.

Example 6. The computer-implemented method of any of the preceding examples, wherein the protected data element is one of a plurality of protected data elements within the input data object and generating the encrypted element representation of the protected data element comprises determining a subset of protected data elements from the plurality of protected data elements that correspond to the privacy type of the protected data element; concatenating each protected data element of the subset of protected data elements to generate a concatenated term subset, wherein each protected data element is separated by a delimiting character; and generating the encrypted element representation by encrypting the concatenated term subset.

Example 7. The computer-implemented method of any of the preceding examples, further comprising receiving a decryption request that identifies the tagged data object; and responsive to the decryption request, overlaying the protected data element over the anonymized privacy tag.

Example 8. The computer-implemented method of example 7, wherein overlaying the protected data element over the anonymized privacy tag comprises decrypting the encrypted element representation; determining the anonymized privacy tag based on the privacy type of the protected data element and a position of the encrypted element representation relative to another encrypted element representation; and overlaying the protected data element over the anonymized privacy tag.

Example 9. The computer-implemented method of any of examples 7 through 8, wherein the protected data element is one of a plurality of protected data elements within the input data object, the decryption request is associated with a priority level, and a portion of the plurality of protected data elements is decrypted based on the priority level.

Example 10. A system comprising one or more processors; and at least one memory storing processor-executable instructions that, when executed by the one or more processors, cause the one or more processors to perform operations comprising detecting a protected data element from an input data object based on privacy criteria; generating a tagged data object from the input data object by replacing the protected data element with an anonymized privacy tag that identifies a privacy type of the protected data element; generating, using an encryption algorithm, an encrypted element representation of the protected data element; inserting the encrypted element representation to a portion of the tagged data object; and storing the tagged data object.

Example 11. The system of example 10, wherein the protected data element is one of a plurality of protected data elements within the input data object, the portion of the tagged data object is a terminating portion of the tagged data object, and the encrypted element representation is inserted at a position within a sequence of encrypted element representations respectively corresponding to the plurality of protected data elements based on a location of the protected data element within the input data object.

Example 12. The system of any of examples 10 through 11, wherein determining the protected data element comprises generating, using a first stream of a parallel model pipeline, a first subset of protected element predictions for a first subset of a set of data elements detected in the input data object by a regular expression stream of the parallel model pipeline; generating, using a second stream of the parallel model pipeline, a second subset of protected element predictions for a second subset of the set of data elements by a text-based matching stream of the parallel model pipeline; generating, using a third stream of the parallel model pipeline, a third subset of protected element predictions for a third subset of the set of data elements by a conditional random field stream of the parallel model pipeline; generating, using a fourth stream of the parallel model pipeline, a fourth subset of protected element predictions for a fourth subset of the set of data elements by a language model stream of the parallel model pipeline; generating an aggregated set of protected element predictions based on the first subset of protected element predictions, the second subset of protected element predictions, the third subset of protected element predictions, and the fourth subset of protected element predictions, wherein the protected data element is part of the set of protected term predictions.

Example 13. The system of any of examples 10 through 12, wherein the encryption algorithm is based on the privacy type of the protected data element.

Example 14. The system of any of examples 10 through 13, wherein the protected data element is one of a plurality of protected data elements within the input data object and generating the encrypted element representation of the protected data element comprises determining a subset of protected data elements from the plurality of protected data elements that correspond to the privacy type of the protected data element; concatenating each protected data element of the subset of protected data elements to generate a concatenated term subset, wherein each protected data element is separated by a delimiting character; and generating the encrypted element representation by encrypting the concatenated term subset.

Example 15. The system of any of examples 10 through 14, wherein the operations further comprise receiving a decryption request that identifies the tagged data object; and responsive to the decryption request, overlaying the protected data element over the anonymized privacy tag.

Example 16. The system of example 15, wherein overlaying the protected data element over the anonymized privacy tag comprises decrypting the encrypted element representation; determining the anonymized privacy tag based on the privacy type of the protected data element and a position of the encrypted element representation relative to another encrypted element representation; and overlaying the protected data element over the anonymized privacy tag.

Example 17. The system of any of examples 15 through 16, wherein the protected data element is one of a plurality of protected data elements within the input data object, the decryption request is associated with a priority level, and a portion of the plurality of protected data elements is decrypted based on the priority level.

Example 18. One or more non-transitory computer-readable storage media storing instructions that, when executed by one or more processors, cause the one or more processors to perform operations comprising detecting a protected data element from an input data object based on privacy criteria; generating a tagged data object from the input data object by replacing the protected data element with an anonymized privacy tag that identifies a privacy type of the protected data element; generating, using an encryption algorithm, an encrypted element representation of the protected data element; inserting the encrypted element representation to a portion of the tagged data object; and storing the tagged data object.

Example 19. The one or more non-transitory computer-readable storage media of example 18, wherein the encrypted element representation comprises an encrypted string generated from the protected data element and a privacy type delimiter associated with the privacy type of the protected data element.

Example 20. The one or more non-transitory computer-readable storage media of any of examples 18 through 19, wherein the protected data element is one of a plurality of protected data elements within the input data object, the portion of the tagged data object is a terminating portion of the tagged data object, and the encrypted element representation is inserted at a position within a sequence of encrypted element representations respectively corresponding to the plurality of protected data elements based on a location of the protected data element within the input data object.

Example 21. The computer-implemented method of example 1, wherein the method further comprises training the parallel model pipeline.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The computing system of example 10, wherein the one or more processors are further configured to train the parallel model pipeline.

Example 25. The computing system of example 24, wherein the one or more processors are included in a first computing entity; and the parallel model pipeline is trained by one or more other processors included in a second computing entity.

Example 26. The one or more non-transitory computer-readable storage media of example 18, wherein the instructions further cause the one or more processors to train the parallel model pipeline.

Example 27. The one or more non-transitory computer-readable storage media of example 26, wherein the one or more processors are included in a first computing entity; and the parallel model pipeline is trained by one or more other processors included in a second computing entity.

What is claimed is:

1. A computer-implemented method comprising:
determining, by one or more processors and a model pipeline, a protected data element from an input data object based on privacy criteria;
generating, by the one or more processors, a tagged data object from the input data object by replacing the protected data element with an anonymized privacy tag that identifies a privacy type of the protected data element;
generating, by the one or more processors and using an encryption algorithm, an encrypted element representation of the protected data element;
inserting, by the one or more processors, the encrypted element representation to a portion of the tagged data object; and
storing, by the one or more processors, the tagged data object.

2. The computer-implemented method of claim 1, wherein the encrypted element representation comprises an encrypted string generated from the protected data element and a privacy type delimiter associated with the privacy type of the protected data element.

3. The computer-implemented method of claim 1, wherein the protected data element is one of a plurality of protected data elements within the input data object, the portion of the tagged data object is a terminating portion of the tagged data object, and the encrypted element representation is inserted at a position within a sequence of encrypted element representations respectively corresponding to the plurality of protected data elements based on a location of the protected data element within the input data object.

4. The computer-implemented method of claim 1, wherein determining the protected data element comprises:
generating, using a first stream of a parallel model pipeline, a first subset of protected element predictions for a first subset of a set of data elements detected in the input data object by a regular expression stream of the parallel model pipeline;
generating, using a second stream of the parallel model pipeline, a second subset of protected element predictions for a second subset of the set of data elements by a text-based matching stream of the parallel model pipeline;
generating, using a third stream of the parallel model pipeline, a third subset of protected element predictions for a third subset of the set of data elements by a conditional random field stream of the parallel model pipeline;
generating, using a fourth stream of the parallel model pipeline, a fourth subset of protected element predictions for a fourth subset of the set of data elements by a language model stream of the parallel model pipeline;
generating an aggregated set of protected element predictions based on the first subset of protected element predictions, the second subset of protected element predictions, the third subset of protected element predictions, and the fourth subset of protected element predictions, wherein the protected data element is part of the set of protected term predictions.

5. The computer-implemented method of claim 1, wherein the encryption algorithm is based on the privacy type of the protected data element.

6. The computer-implemented method of claim 1, wherein the protected data element is one of a plurality of protected data elements within the input data object and generating the encrypted element representation of the protected data element comprises:
determining a subset of protected data elements from the plurality of protected data elements that correspond to the privacy type of the protected data element;
concatenating each protected data element of the subset of protected data elements to generate a concatenated term subset, wherein each protected data element is separated by a delimiting character; and
generating the encrypted element representation by encrypting the concatenated term subset.

7. The computer-implemented method of claim 1, further comprising:
receiving a decryption request that identifies the tagged data object; and
responsive to the decryption request, overlaying the protected data element over the anonymized privacy tag.

8. The computer-implemented method of claim 7, wherein overlaying the protected data element over the anonymized privacy tag comprises:
decrypting the encrypted element representation;
determining the anonymized privacy tag based on the privacy type of the protected data element and a position of the encrypted element representation relative to another encrypted element representation; and
overlaying the protected data element over the anonymized privacy tag.

9. The computer-implemented method of claim 7, wherein the protected data element is one of a plurality of protected data elements within the input data object, the decryption request is associated with a priority level, and a portion of the plurality of protected data elements is decrypted based on the priority level.

10. A system comprising one or more processors; and at least one memory storing processor-executable instructions that, when executed by the one or more processors, cause the one or more processors to perform operations comprising:
detecting a protected data element from an input data object based on privacy criteria;
generating a tagged data object from the input data object by replacing the protected data element with an anonymized privacy tag that identifies a privacy type of the protected data element;
generating, using an encryption algorithm, an encrypted element representation of the protected data element;
inserting the encrypted element representation to a portion of the tagged data object; and
storing the tagged data object.

11. The system of claim 10, wherein the protected data element is one of a plurality of protected data elements within the input data object, the portion of the tagged data object is a terminating portion of the tagged data object, and the encrypted element representation is inserted at a position within a sequence of encrypted element representations respectively corresponding to the plurality of protected data elements based on a location of the protected data element within the input data object.

12. The system of claim 10, wherein determining the protected data element comprises:
generating, using a first stream of a parallel model pipeline, a first subset of protected element predictions for a first subset of a set of data elements detected in the input data object by a regular expression stream of the parallel model pipeline;
generating, using a second stream of the parallel model pipeline, a second subset of protected element predictions for a second subset of the set of data elements by a text-based matching stream of the parallel model pipeline;
generating, using a third stream of the parallel model pipeline, a third subset of protected element predictions for a third subset of the set of data elements by a conditional random field stream of the parallel model pipeline;
generating, using a fourth stream of the parallel model pipeline, a fourth subset of protected element predictions for a fourth subset of the set of data elements by a language model stream of the parallel model pipeline;
generating an aggregated set of protected element predictions based on the first subset of protected element predictions, the second subset of protected element predictions, the third subset of protected element predictions, and the fourth subset of protected element predictions, wherein the protected data element is part of the set of protected term predictions.

13. The system of claim 10, wherein the encryption algorithm is based on the privacy type of the protected data element.

14. The system of claim 10, wherein the protected data element is one of a plurality of protected data elements within the input data object and generating the encrypted element representation of the protected data element comprises:
determining a subset of protected data elements from the plurality of protected data elements that correspond to the privacy type of the protected data element;
concatenating each protected data element of the subset of protected data elements to generate a concatenated term subset, wherein each protected data element is separated by a delimiting character; and
generating the encrypted element representation by encrypting the concatenated term subset.

15. The system of claim 10, wherein the operations further comprise:
receiving a decryption request that identifies the tagged data object; and
responsive to the decryption request, overlaying the protected data element over the anonymized privacy tag.

16. The system of claim 15, wherein overlaying the protected data element over the anonymized privacy tag comprises:
decrypting the encrypted element representation;
determining the anonymized privacy tag based on the privacy type of the protected data element and a position of the encrypted element representation relative to another encrypted element representation; and
overlaying the protected data element over the anonymized privacy tag.

17. The system of claim 15, wherein the protected data element is one of a plurality of protected data elements within the input data object, the decryption request is associated with a priority level, and a portion of the plurality of protected data elements is decrypted based on the priority level.

18. One or more non-transitory computer-readable storage media storing instructions that, when executed by one or more processors, cause the one or more processors to perform operations comprising:
detecting a protected data element from an input data object based on privacy criteria;
generating a tagged data object from the input data object by replacing the protected data element with an anonymized privacy tag that identifies a privacy type of the protected data element;
generating, using an encryption algorithm, an encrypted element representation of the protected data element;
inserting the encrypted element representation to a portion of the tagged data object; and
storing the tagged data object.

19. The one or more non-transitory computer-readable storage media of claim 18, wherein the encrypted element representation comprises an encrypted string generated from the protected data element and a privacy type delimiter associated with the privacy type of the protected data element.

20. The one or more non-transitory computer-readable storage media of claim 18, wherein the protected data element is one of a plurality of protected data elements within the input data object, the portion of the tagged data object is a terminating portion of the tagged data object, and the encrypted element representation is inserted at a position within a sequence of encrypted element representations respectively corresponding to the plurality of protected data elements based on a location of the protected data element within the input data object.
